(19) United States
(12) Patent Application Publication
(10) Pub. No.: US 2015/0136190 A1
(43) Pub. Date: May 21, 2015

(54) Adjustable Walking Frame

(71) Applicant: David Thomas, COTTINGHAM (GB)

(72) Inventor: David Thomas, COTTINGHAM (GB)

(21) Appl. No.: 14/541,489

(22) Filed: Nov. 14, 2014

Related U.S. Application Data
(60) Provisional application No. 61/906,174, filed on Nov. 19, 2013.

(51) Int. Cl. A61H 3/00; A61H 3/04

(52) U.S. Cl. CPC A61H 3/00; A61H 3/04; A61H 2201/0161; A61H 2201/0192
USPC 135/67; 280/638

(57) ABSTRACT

An adjustable walking frame design for walking aid device is provided. The adjustable walking frame has a pair of beam assemblies where the pair of beam assemblies is pivotally mounted to each other. The pivotal mounting provides flexible angle adjustment between the pair of beam assemblies. The height and width of the beam assemblies can be adjusted to meet individual's physical measurements. The adjustable walking frame can be collapsed to occupy minimal space when the adjustable walking frame is stored or transported.

### CROSS-REFERENCE TO RELATED APPLICATIONS

This application is a non-provisional application which claims the benefit to Provisional Application No. 61/906,174 filed on Nov. 19, 2013.

### BACKGROUND

1. Field of the Invention

The present invention relates generally to medical appliances. More particularly the present invention relates to an adjustable walking frame designed to provide support to a user while walking.

2. Description of Related Art

Many elderly patients or people with disabilities often require walking aid that provides structural support while walking. A walking frame provides structural supports to aid a person to balance better or to provide vertical support while walking. While there are currently many available walking frames, most of them are designed to support a single patient's body attributes, such as height and length of arms. Currently available walking frames are limited in its adjustability. The adjustability of the walking frames often requires multiple added elements to allow adjustment in height or width of the walking frame. Moreover, walking frames are often bulky in design and heavy, as such they are not very convenient to transport or store when it is not in use.

Therefore, what is needed is a walking frame that is adjustable in heights and widths to accommodate various sizes of patients while collapsible and less bulky to provide ease in transporting and storing.

### SUMMARY

The subject matter of this application may involve, in some cases, interrelated products, alternative solutions to a particular problem, and/or a plurality of different uses of a single system or article.

In one aspect, an adjustable walking frame is provided. The adjustable walking frame may comprise a pair of beam assemblies pivotally mounted about a pivot axis, where the pivot axis may be located near at a center of each of the pair of beam assemblies. The pair of beam assemblies may define a pivot angle when in an open position, and the pair of beam assemblies may be pivotable towards each other within a pivot plane defined by the pivot angle. The pair of beam assemblies may be pivotable between the open position and a closed position, where the pivot angle is substantially zero when in the closed position.

Further, each of the pair of beam assemblies may comprise an upper beam and a lower beam. The upper beam may form a handle at a distal end with respect to the pivot axis, and may be positioned to be grasped by a user. The lower beam may form a foot at a distal end, and may be positioned to contact a ground. Each of the pair of beam assemblies may be adjustable by extending and retracting each of the pair of beam assemblies along its length, enabling adjustment in height of the adjustable walking frame, and enabling adjustment in width defined between the handles when in the open position.

In another aspect, an adjustable walking frame may comprise a first pivot piece and a second pivot piece. The pivot pieces may be pivotally mounted to each other about a pivot axis, where the first pivot piece and the second pivot piece are pivotally spaced apart from each other defining a pivot angle when in an open position. The first and second pivot pieces may be pivotable within a pivot plane defined by the pivot angle, and the first and second pivot pieces may be pivotable between the open position and a closed position. At the closed position, the pivot angle may be substantially zero.

The adjustable walking frame may further comprise a pair of beam assemblies, where each of the pair of beam assemblies may be segmented into an upper beam and a lower beam. The upper beam may form a handle at a distal end and a first end at a proximal end. Similarly, the lower beam may form a foot at a distal end and a second end at a proximal end.

Each of the first pivot piece and the second pivot piece may comprise a first aperture and a second aperture, where the first aperture and the second aperture may be formed along a length of the respective pivot pieces. They may be parallel to each other. The first aperture may be sized to slidably receive the first end and the second aperture may be sized to slidably receive the second end. The first end and the second end may further be received by the respective apertures in an opposing direction.

Each of the pair of beam assemblies may be independently adjustable by extending and retracting each of the pair of beam assemblies along its length through one or more of the first aperture and the second aperture. Thereby, enabling adjustment in height of the adjustable walking frame, and enabling adjustment in width defined between the handles when in the open position.

In yet another aspect, a method of adjusting the above identified devices is provided. The method comprises reducing the width between the handles of the adjustable walking frame by retracting at least one of the upper beam of the pair of beam assemblies; increasing the width between the handles of the adjustable walking frame by extending at least one of the upper beam of the pair of beam assemblies; reducing the height of the adjustable walking frame by retracting at least one of the upper beam and the lower beam of the pair of beam assemblies; and increasing the height of the adjustable walking frame by extending at least one of the upper beam and the lower beam of the pair of beam assemblies.

### BRIEF DESCRIPTION OF THE DRAWINGS

FIG. 1 provides an embodiment of an adjustable walking frame in a perspective view.

FIG. 2 provides another embodiment of the adjustable walking frame in a side view.

FIG. 3 provides a yet another embodiment of the adjustable walking frame in a front view.

FIG. 4 provides an exemplary embodiment of the pair of pivot pieces.

FIG. 5 provides an exemplary embodiment of a detailed pivotal relation between the pair of pivot pieces.

FIG. 6 provides an exemplary embodiment of the adjustable walking frame collapsed to have the pivot angle at zero.

FIG. 7 provides an embodiment of the adjustable walking frame with a plurality of globes placed at corner of the lower beam.

FIG. 8 provides another embodiment of the adjustable walking frame with a plurality of globes placed at corner of the lower beam.

FIG. 9 provides an exemplary embodiment of the adjustable walking frame mounted with a wheel member.

FIG. 10 provides a close up view of the exemplary embodiment of the wheel member being mounted to the globe.

FIG. 11 provides an embodiment of the adjustable walking frame when it is collapsed to provide ease in storing and transporting.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present disclosure concerns an adjustable walking frame designed to aid a patient while walking. The adjustable walking frame provides height and width adjustments to fit different users with various physical attributes and physiques. The present disclosure also adds versatility to the space the adjustable walking frame takes when it is stored or transported. Such versatility is achieved by a pivotal mounting mechanism and an adjustable extension mechanism which allow the entire structure to collapse into a minimal volume or a storage position.

The present disclosure provides an adjustable walking frame being generally shaped in ‘X’ shaped structure. In an embodiment, the adjustable walking frame comprises a pair of beam assemblies that are pivotally mounted to each other to provide adjustment in a pivot angle defined by the pivoting movement. The length of the each of the pair of beam assemblies may be adjusted to accommodate different physiques of the user. The adjustable walking frame may be opened at the pivot angle and may be collapsed or closed to the pivot angle of substantially zero, thereby providing compact storage position.

In another embodiment, a pair of beam assemblies may form a pivotal relation to each other via a pair of pivot pieces. The pair of pivot pieces may be pivotally mounted to each other about a pivot axis. One of the pair of pivot pieces may receive one of the pair of beam assemblies, and the other of the pair of pivot pieces may receive the other of the pair of beam assemblies. Thereby the pair of beam assemblies can exercise a scissors action. The pivot piece may be of any size and shape.

Each of the beam assemblies may comprise a handle and a foot where the handle is grabbed by the user when in use, and the foot being in contact with the ground when the adjustable walking frame is pressed against the ground.

Further the present disclosure provides a method of adjusting the adjustable walking frame, where variety of orientations of adjustable walking frame may be achieved by adjusting the length of the beam assemblies and pivot angle therein. In one embodiment, each of the pair of beam assemblies may be independently or collectively extend or retract along its length.

An adjustable walking frame for aiding a user when walking is provided. The adjustable walking frame generally may comprise a pair of beam assemblies where the pair of beam assemblies is pivotally affixed to each other. In some embodiments, the pair of beam assemblies may be pivotally affixed to one another by a pair of pivot pieces.

Each of the pair of beam assemblies may comprise an upper beam and a lower beam. The upper beam may generally have an upside down L-shape structure which may be made of a uniform beam. The upper beam may comprise a handle and a first end, where the upper beam extends at an angle downwardly towards the ground from the handle forming the first end at a proximal end with regards to the pivot axis. The lower beam generally may have an L-shape structure which may be made of a uniform beam. The lower beam may comprise a foot and a second end, where the lower beam extends at an angle upwardly away from the ground from the foot forming the second end at a proximal end with regards to the pivot axis. In one embodiment, the upper beam and the lower beam may be of a continuous bream. In another embodiment, each of the pair of beam assemblies may be segmented into the upper beam and the lower beam.

In some embodiments, the first end and the second end may be coupled to one of the pair of pivot pieces. Each of the pair of pivot pieces may form a first aperture and a second aperture formed along a length of the pivot piece, parallel to each other in an extending direction, and may be configured to slidably receive the first end and the second end respectively. The first end and the second end may be adjustable in length through the first aperture and the second aperture, respectively. The pair of pivot pieces may be configured to mate in a pivotal relation to allow pivoting movement of each of the pair of beam assemblies resulted from the pivotal relation of the pair of pivot pieces. The pair of pivot pieces may be pivotable within a pivot plane defined by the pivot angle created, when the pair of pivot pieces pivots from an open position to a closed position.

In some embodiments, each of the pair of pivot pieces may form an aperture formed along a length of each of the pivot pieces in an extending direction. The aperture may slidably receive the first end and the second end at its opposite ends respectively.

In some embodiments, the upper beam and the lower beam may be independently or collectively extend or retract along its length, resulting in a length adjustment of the pair of beam assemblies.

In some embodiments, the foot of the lower beam may comprise a wheel member, contacting the ground, adding additional mobility when the adjustable walking frame is in use. The wheel member allows a user to push the adjustable walking frame instead of lifting it to move. A plurality of globes may be placed at each corner of bent beams to provide cushion and stability when pressured.

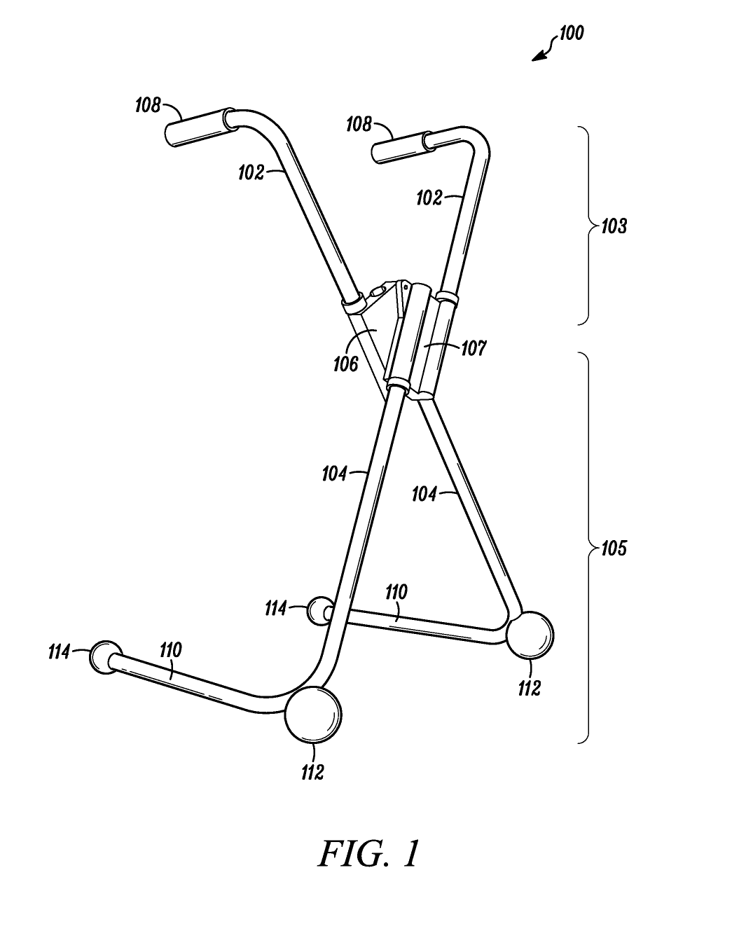

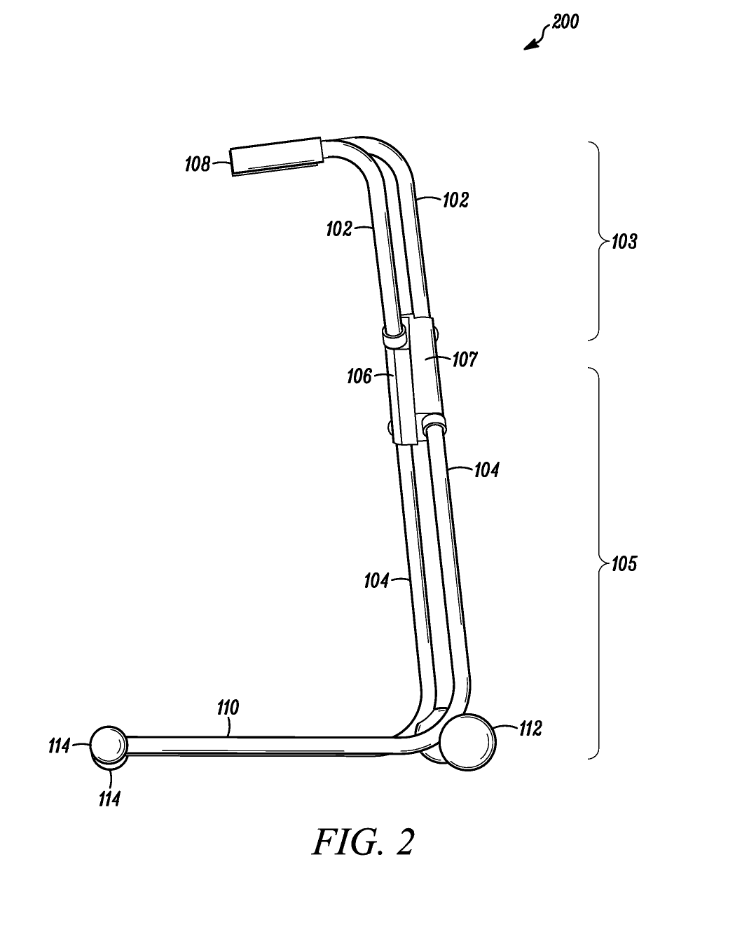

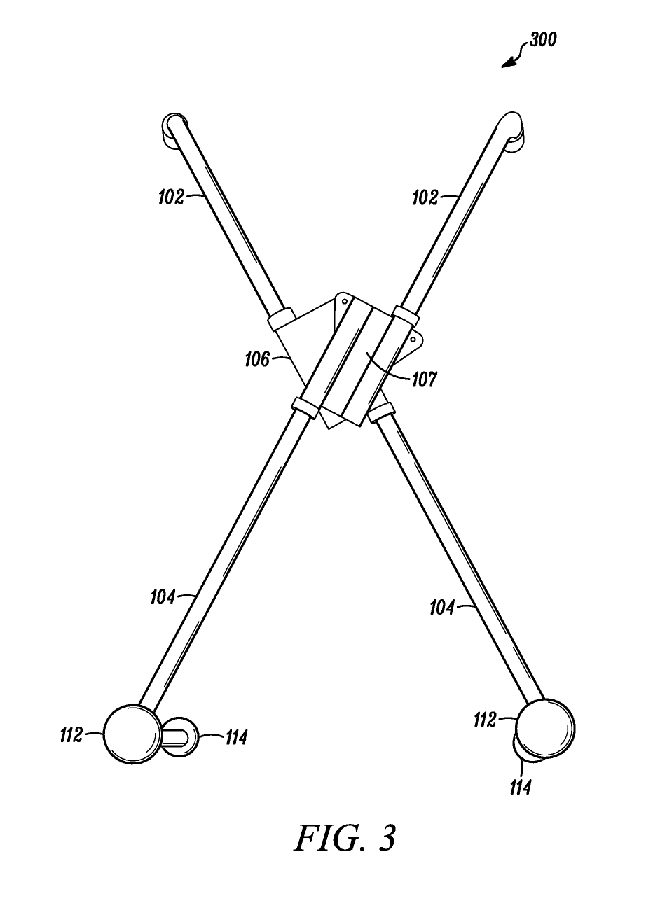

FIG. 1-3 show embodiments of an adjustable walking frame at an open position viewed from various angles 100 200 300. In these embodiments, the adjustable walking frame comprises a pair of beam assemblies pivotally mounted around a center of the pair of beam assemblies about the pivot axis.

As shown in FIG. 1-3, each of the pair of beam assemblies comprises an upper beam 103 and a lower beam 105. The upper beam 103 and the lower beam 105 are connected by one of a pair of pivot pieces 106 and 107. The upper beam 103 has a handle 108 which extends at an angle to form a first end 102, and the handle is positioned at a distal end from the pivot axis. The lower beam 105 has a foot 110 which makes contact with the ground and further forms a second end 104 extending from the foot 110 away from the ground, and the foot is positioned at a distal end from the pivot axis. The first end 102 and the second 104 end are connected by one of the pair of pivot pieces 106 or 107.

Each of the pair of beam assemblies is pivotable about the pivot axis via the pair of pivot pieces. The pair of pivot pieces are pivotally mounted to each other about the pivot axis, where each of the pair of pivot pieces forming a pivot angle when the adjustable walking frame is in the open position. The pivot angle is adjustable about the pivot axis. The pair of pivot pieces is pivotable within the pivot plane defined by the pivot angle about the pivot axis. At the closed position, the pivot angle is substantially at zero.

In one embodiment, each of the pair of beam assemblies may be slidably coupled to one of the pair of pivot pieces, which allows the pair of beam assemblies to be adjusted by sliding towards and away from the pair of pivot pieces. The pair of pivot pieces may be located at the center of the pair of beam assemblies, where the pivot axis is located.

In another embodiment, the upper beam 103 and the lower beam 105 may be slidably coupled to one of the pair of pivot pieces in parallel relation, at a distance from one another. The first end 102 and the second 104 end are slidably received by the pair of pivot pieces, where one of the pair of pivot pieces 106 receives the first end and the second end from one of the pair of beam assemblies, and the other of the pair of pivot pieces 107 receives the first end and the second end from the other of the pair of beam assemblies. In this embodiment shown in FIG. 1-3, each of the pair of beam assemblies are segmented into the upper beam and the lower beam, where each of them are slidably received by corresponding pivot pieces 106 107 within the plane thereof. The upper beam and the lower beam may extend and retract in an opposing direction from one another.

A plurality of globes 112, 114 may be placed at a bending point of the lower beam 104 making contact with the ground. The plurality of globes 112 may provide required friction and cushion to aid a user while the adjustable walking frame is in use.

In one embodiment, the handles 108 and the foot 110 may extend at a various angles, so long as the handle is positioned to be graspable by the user and the foot provides contact against the ground when the adjustable walking frame is in use.

In another embodiment, the upper beam and the lower beam may be a continuous structure where the two beams are mounted end-to-end to form a straight and continuous beam structure. The upper beam and the lower beam may extend and retract in an opposing direction from one another.

In yet another embodiment, the pivot angle may be limited to prevent the pair of beam assemblies from widening beyond a desired pivot angle, setting a maximum angle between the upper beams 102 about the pivot angle defined by the angle between the pair of pivot pieces.

In a further embodiment, the first end 102 and the second end 104 may be slidably mounted to one of the pair of pivot pieces in a parallel relation. Thereby, the upper beam and the lower beam are adjustable by extension and retraction. Lengths of the each of the pair of beam assemblies are adjustable by independently adjusting at least one of the upper beams or lower beams. Length adjustment of the upper beam may not only provide adjustability in height of the adjustable walking frame, but also provide adjustability in width between the handles when each of the pair of beam assemblies are at the open position. The pivot angle also may be adjustable where the pair of pivot pieces may be pivoted away from each other to form a pivot angle at an open position. The pivot pieces may be at a closed position when the pivot angle is substantially zero, thereby the pair of beam assemblies are in parallel to each other.

A locking member may be placed to keep the lower beam and the upper beam in place once the adjustable walking frame reaches a desired height or length. The locking member may be releasable. The locking member may be formed on each of the beam assemblies limiting the adjustment of the each of the beam assemblies individually. Similarly, the locking member may be formed on at least one of the upper beam of the lower beam, individually limiting their adjustment, when the locking member is engaged.

In a further embodiment, the upper beam 103 and the lower beam 105 may have a telescopic extending mechanism. Such telescopic extending mechanism is well known in the art to a person of ordinary skills in the art.

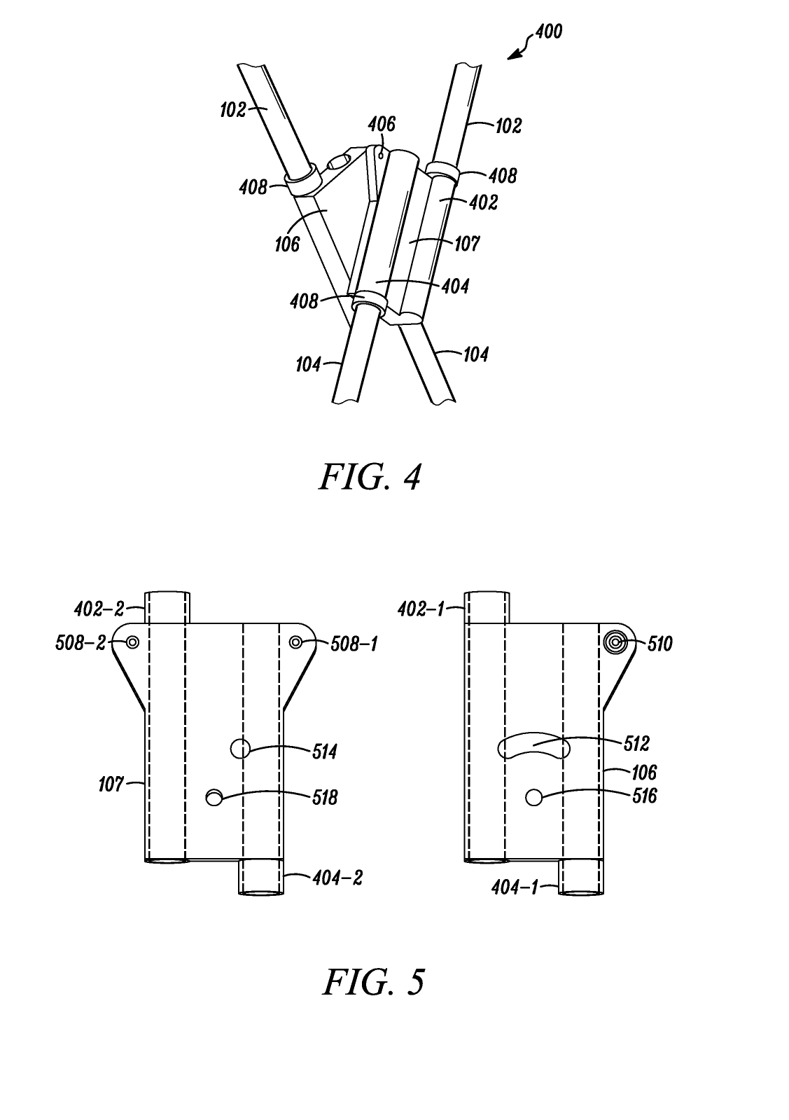

In FIG. 4, 400 shows an exemplary embodiment of the pair of pivot pieces. The pair of pivot pieces 106 and 107 is pivotally mounted to each other allowing adjustment of the pivot angle. A pivot locking member 406 prevents the upper beams 102 or the lower beams 104 from collapsing inwardly to form a pivot angle beyond zero or widening beyond a desired pivot angle (maximum pivot angle). The pivot locking member 406 may releasably affix the pair of pivot pieces 106 and 107 in place at the maximum pivot angle.

Each of the pair of pivot pieces 106, 107 may comprise a first aperture 402 and a second aperture 404 formed along a length of the pivot piece 106 107 parallel to each other, at a distance, in an extending direction configured to receive the first end 102 and the second end 104 respectively in an opposing direction. The first and second aperture slidably receives the first end 102 and the second end 104 respectively, allowing adjustments of length of the upper beam 103 and the lower beam 105, as well as allowing adjustment of the width between the handles of each of the pair of beam assemblies.

In one embodiment, the pivot locking member 406 may be a snap fit mechanism where a pivot locking aperture is formed to receive a pivot locking arm. The pivot locking aperture may be formed on one of the pair of pivot pieces configured to receive the pivot locking arm formed on another one of the pair of pivot pieces. The pivot locking aperture and the pivot locking arm may be positioned to limit the pivot angle at a desired angle when the pivot locking member is received by the pivot locking aperture. The pivot locking member may be releasable once the pivot locking member is disengaged.

In another embodiment, the locking members 408 may be placed on the first ends 102 and the second ends 104. The locking members 408 may releasable lock in the first ends and the second ends, when they are at desired lengths.

FIG. 5 shows an exemplary embodiment of a detailed pivotal relation between the pair of pivot pieces. The pair of pivot pieces, a first pivot piece 107 and a second pivot piece 106 are configured to be pivotally mounted together sharing a contact surface in a face to face relation. The contact surface includes a pivot plane defined by the pivot angle where the first pivot piece and the second pivot piece pivots about the pivot axis. The first aperture 402-1, 402-2 and the second aperture 404-1, 404-2 are shown, each formed length wise through the first pivot piece 107 and the second pivot piece 106 respectively. In this embodiment, the first and second apertures are formed parallel to one another within the plane thereof. The contact surface (the pivot plane) may be substantially flat and smooth, allowing a smooth and frictionless sliding when the first pivot piece 107 and the second pivot piece 106 are pivotally attached in a face to face relation. The first aperture 402s and the second apertures 404s are positioned to slidably receive the first end and the second end respectively, in opposing directions. As such, the upper beam and the lower beam may extend away from each other and retract towards each other.

The first pivot piece 107 and the second pivot piece 106 may be configured to mate about a pivot axis to create a pivotal relation. In one embodiment, the first pivot piece 107 may comprise a pivot slot 518 formed at the pivot axis. The second pivot piece 106 may comprise a pivot arm 516 sized to engage the pivot slot 518 at the pivot point, creating a pivotal relation between the first pivot piece 107 and the second pivot piece 106, when engaged across the pivot plane thereof.

Embodiments of the pivot locking member, a mechanism for limiting the pivot angle between pivotally connected pair of pivot pieces, are provided. The first pivot piece 107 may further comprise a pair of ball catch slots 508-1, 508-2 and a projecting stud 514 formed at the contact surface. The second pivot piece 106 may comprise a ball catch 510 and a curved slot 512 formed at the contact surface.

In one embodiment, the pivot locking member may be a ball catch mechanism. The pair of ball catch slots 508-1, 508-2 may be formed at the pivot plane of the first pivot piece 107. The pair of ball catch slots 508-1, 508-2 may selectively engage with the ball catch 510, formed on the contact surface of the second pivot piece 106. The ball catch slot to ball catch engagement is releasable. Once the first pivot piece 107 and the second pivot piece 106 are pivotally affixed, the pair of ball catch slots 508 may be placed at a distance from each other determining a boundary of the pivot angle when the ball catch 510 engages with either one of the pair of ball catch slots 508-1, 508-2. Thereby, when either one of the pair of ball catch slots 508-1, 508-2 engages with the ball catch 510, an accidental closing of the pair of pivot pieces may be prevented. The pair of ball catch slots 508-1, 508-2 may releasably retain the ball catch 510 when engaged.

In another embodiment, the projecting stud 514 may engage with the curved slot 512 to limit the pivot angle between pivotally connected pair of pivot pieces 107 106. The projecting stud 514 may be formed on the surface of the first pivot piece 107, positioned to slidably mate with the curved slot 512 formed on the surface of the second pivot piece 106. The curved slot 512 may form a pivotal trajectory, guiding a pivotal movement of the projecting stud 514 about the pivot axis defined by pivot arm 516 and pivot slot 518. The projecting stud 514 may lock into the curved slot 512 to enable the pair of pivot pieces 107 106 to pivotally engage firmly. The curved slot 512 may form a cavity along the pivotal trajectory, setting boundaries to the pivotal engagement between the first pivot piece 107 and the second pivot piece 106, when the projecting stud 514 is engaged to the curved slot 512.

A person of ordinary skills in the art would appreciate that the mechanism for limiting the pivot angle between pivotally connected pair of pivot pieces may be modified to achieve the desired range of pivot angles between the pair of pivot pieces about the pivot axis.

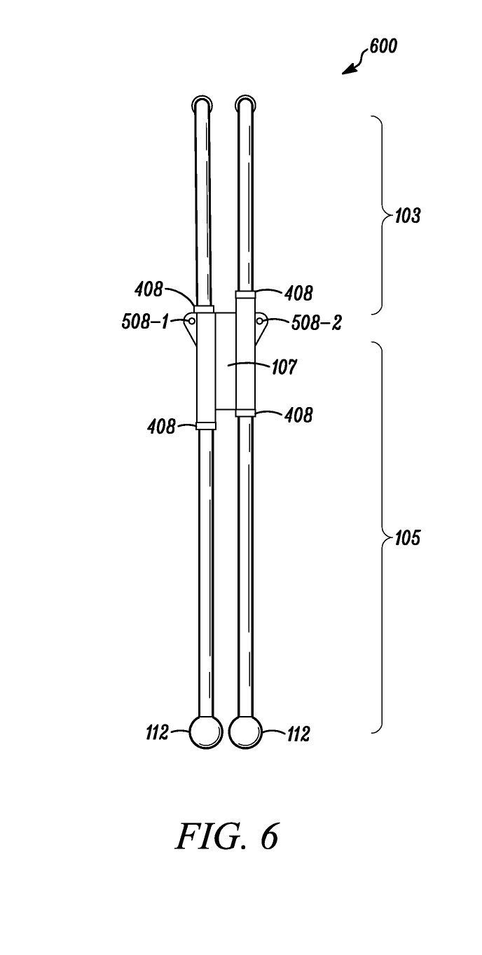

FIG. 6 shows an exemplary embodiment of the adjustable walking frame collapsed having the pivot angle between the pair of beam assemblies at zero. The adjustable walking frame 600 is at the closed position. The adjustable walking frame, when collapsed 600, may be configured to prevent each of the pair of beam assemblies from pivoting inwardly about the pair of pivot pieces 106 107 pass the pivot angle of zero.

In one embodiment, the pivot locking member 508-1 508-2 may be placed to keep the collapsed adjustable walking frame 600 in a collapsed position for convenient storing and transporting.

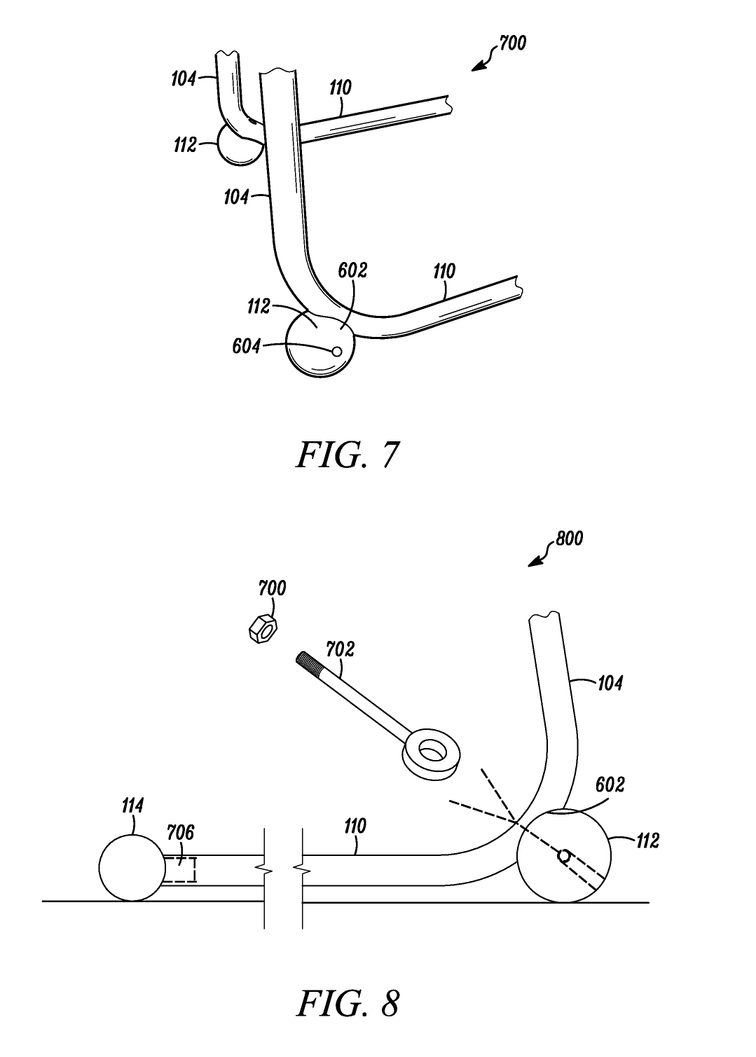

FIGS. 7 and 8 illustrate the plurality of globes 112 placed at corners of the lower beam, show in a perspective view 700 and in a dissected view 800. One of the plurality of globes 112 is fitted at the corner of the lower beam where the foot 110 and the second end 104 meets. A groove 602 may be formed along a surface of the globe 112, configured to mate with the lower beam.

In one embodiment, a globe aperture 604 is formed on the globe 112 configured to receive a wheel member.

In another embodiment, the globe 112 provides cushion and stability to a user once the user puts pressure on the adjustable walking frame against the ground. The globe 112 may be made of a flexible material or a shock absorbent material.

In yet another embodiment, the globe may be affixed to the lower beam by bolt and nut mechanism, as shown in FIG. 8. In order to receive the globe 112 in a locked position, in some embodiments, the globe may be affixed to the corners of the lower beam through a central axis of the globe, configured to receive a bolt 702 and nut 700 to securely mount the globe 112 to the corner of the second end 104 and the foot 110.

In a further embodiment, another globe 114 may be placed at an end of the foot 110, contacting the ground. The globe 114 may also provide cushion and stability to a user once the user puts pressure on the adjustable walking frame. The globe 112 114 may be made of a high friction material, preventing slipping when in use. In some embodiments, the globe 114 may be socketed 706 into the foot beam, where the foot beam is made of a hollow tube.

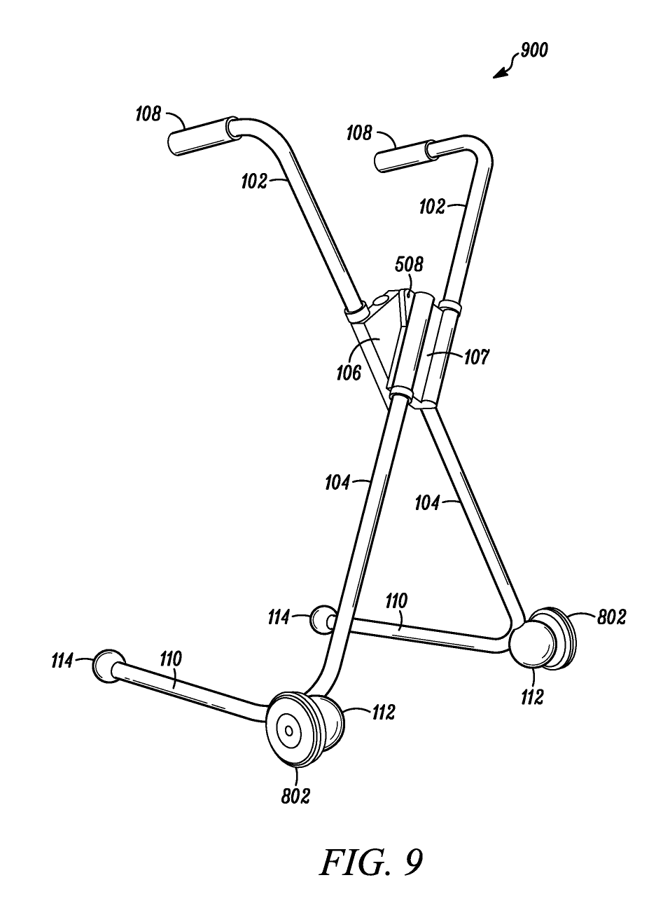

FIG. 9 illustrates an exemplary embodiment of the adjustable walking frame mounted with wheel member 802 at the open position 900. Each of the globes 112 may be affixed to the wheel member 802, providing additional mobility to the user when the wheel member makes contact to the ground. In this embodiment, the adjustable walking frame is shown at the open position. Alternatively, the wheel member may increase transportability to the adjustable walking frame when in the closed position.

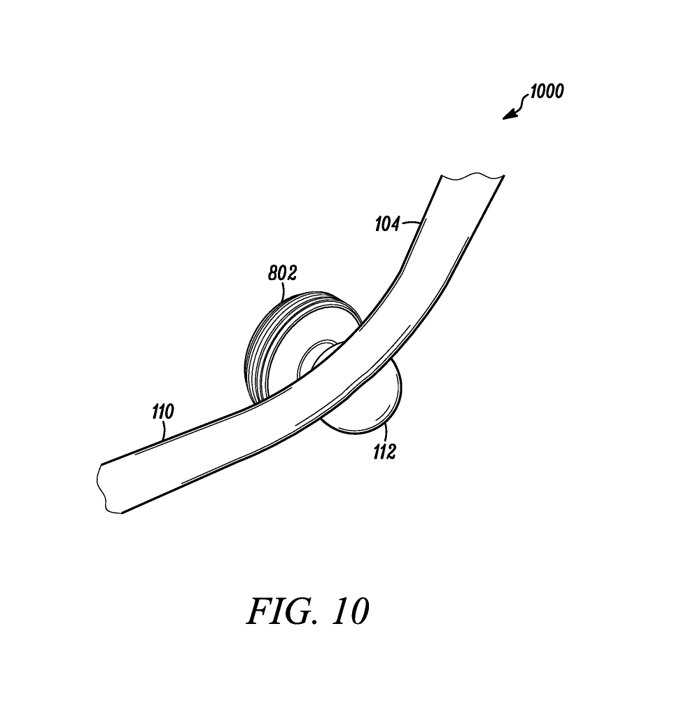

FIG. 10 illustrates a close up view 1000 of the exemplary embodiment of the wheel member 802 being mounted to the globe 112. The wheel member 802 provides the user with mobility when the adjustable walking frame is in use. The wheel member 802 allows the user to roll the adjustable walking frame on the ground instead of lifting it to move forward.

A person of ordinary skills in the art would appreciate that the attachment of the wheel member 802 to the adjustable walking frame may be modified to achieve additional mobility when the adjustable walking frame is in ues.

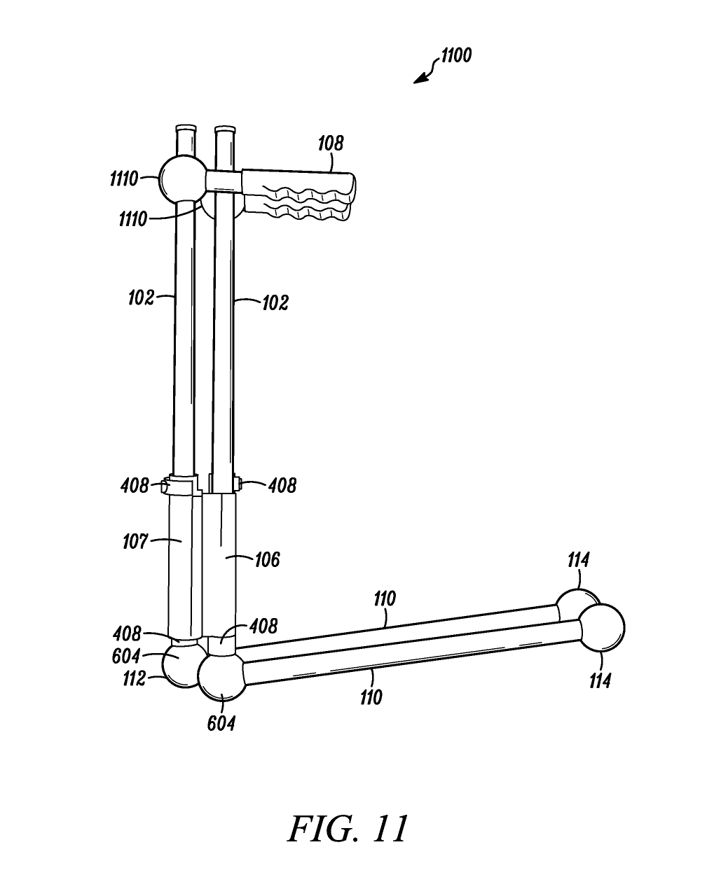

FIG. 11 shows an embodiment of the adjustable walking frame when it is fully collapsed to provide ease in storing and transporting. The lower beam is pushed towards the handle 108 through the second aperture to collapse into a minimal volume. In this embodiment, the adjustable walking frame is at a storage position 1100, where the adjustable walking frame is fully retracted by retracting the pair of beam assemblies, while the pivot angle is kept substantially at zero. The locking member 408 may releasably limit the pair of beam assemblies from extending or retracting in length. As such, the locking member 408 may prevent the first end 102 and the second end 104 from either retracting or extending.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

Those skilled in the at will readily observe that numerous modifications, applications and alterations of the device and method may be made while retaining the teachings of the present invention.

What is claimed is:

1. An adjustable walking frame comprising:
a pair of beam assemblies pivotally mounted about a pivot axis, the pivot axis located near at a center of each of the pair of beam assemblies, wherein the pair of beam assemblies defines a pivot angle when in an open position, the pair of beam assemblies being pivotable towards each other within a pivot plane defined by the pivot angle, and the pair of beam assemblies being pivotable between the open position and a closed position, wherein the pivot angle is substantially zero when in the closed position;
each of the pair of beam assemblies comprising an upper beam and a lower beam, the upper beam forming a handle at a distal end, positioned to be grasped by a user, and the lower beam forming a foot at a distal end, positioned to contact a ground; and
each of the pair of beam assemblies being adjustable by extending and retracting each of the pair of beam assemblies along its length, enabling adjustment in height of the adjustable walking frame, and enabling adjustment in width defined between the handles when in the open position.

2. The adjustable walking frame of claim 1 wherein the upper beam and the lower beam are formed in a continuous structure.

3. The adjustable walking frame of claim 1 wherein each of the pair of beam assemblies are constructed with telescoping adjustment mechanism to enable each of the pair of beam assemblies to be adjustable by extending and retracting each of the pair of beam assemblies along its length.

4. The adjustable walking frame of claim 1 further comprising a pivot locking member, configured to prevent the pair of beam assemblies from pivoting away from each other beyond a desired pivot angle at the open position, when engaged.

5. The adjustable walking frame of claim 1 wherein each of the pair of beam assemblies further comprises a locking member releasably positioned on each of the pair of beam assemblies, limiting the extending and retracting of each of the pair of beam assemblies, when engaged.

6. The adjustable walking frame of claim 1 further comprising a wheel member affixed to the foot, the wheel member providing added mobility to the adjustable walking frame when the wheel member is in contact with the ground.

7. The adjustable walking frame of claim 1 further comprising a globe, the globe being placed to make contact with the ground when the adjustable walking frame is pressed against the ground.

8. The adjustable walking frame of claim 1, wherein the globe is made of a material selected from the group consisting of high friction material, shock absorbent material, elastic material, and slip resistant material.

9. The adjustable walking frame of claim 1 further comprising a first pivot piece and a second pivot piece, each of the pair of beam assemblies being segmented into the upper beam and the lower beam, the first pivot piece coupled to one of the pair of beam assemblies, the second pivot piece coupled to the other of the pair of beam assemblies, wherein:
the pair of beam assemblies are pivotally mounted about the pivot axis via a first pivot piece and a second pivot piece;
the first pivot piece and the second pivot piece being pivotally mounted to each other about the pivot axis, the first and second pivot pieces being pivotable within the pivot plane defined by the pivot angle, and the first and second pivot pieces being pivotable between the open position and the closed position;
the upper beam forming a first end at a proximal end, the lower beam forming a second end at a proximal end;
each of the first pivot piece and the second pivot piece comprises at least one aperture, the at least one aperture being formed along a length of the respective one of the pair of pivot pieces, sized to slidably receive at least one of the first end and the second end, the first end and the second end being received by the at least one aperture in an opposing direction; and
each of the pair of beam assemblies being independently adjustable by extending and retracting each of the pair of beam assemblies along its length through the at least one aperture.

10. The adjustable walking frame of claim 9 further comprising a pivot locking member having a snap fit mechanism, the pivot locking member positioned to affix the pivot angle at a desired angle, wherein the pivot locking member comprises:
a pivot locking aperture formed at the first pivot piece; and
a pivot locking arm formed at the second pivot piece, wherein the pivot locking aperture engages the pivot locking arm across the pivot plane, affixing the first pivot piece to the second pivot piece when engaged, and the pivot locking arm being releasable to disengage the pivot locking member.

11. The adjustable walking frame of claim 9 further comprising a pivot locking member having a ball catch mechanism, the pivot locking members positioned to affix the pivot angle at the open position and the closed position, wherein the pivot locking member comprises:
a ball catch slot formed at the first pivot piece; and
a ball catch formed at the second pivot piece, wherein the ball catch engages the ball catch slot across the pivot plane, affixing the first pivot piece to the second pivot piece when engaged at the open position or the closed position, and the ball catch being releasable to disengage from the ball catch slot.

12. The adjustable walking frame of claim 9 further comprising a projecting stud and a curved slot, positioned to provide a pivotal trajectory between the first pivot piece and the second pivot piece when engaged, the curved slot being formed at the second pivot piece, the projecting stud being formed at the first pivot piece, wherein the projecting stud and the curved slot slidably mates across the pivot plane, the curved slot defined by the pivotal trajectory, the projecting stud being slidably locked into the curved slot, thereby pivotally engaging the first and second pivot pieces moveably along the curved slot.

13. The adjustable walking frame of claim 9 wherein each of the upper beam and the lower beam further comprises a locking member releasably positioned to limit the extending and retracting of each of the pair of beam assemblies, when engaged.

14. The adjustable walking frame of claim 9 wherein the first pivot piece further comprises a pivot slot, and the second pivot piece further comprises a pivot arm, the pivot slot being pivotally mounted at the pivot axis by engaging the pivot arm, the pivot slot and the pivot arm positioned to engage across the pivot plane, enabling the first pivot piece and the second pivot piece to be pivotally mounted to each other.

15. An adjustable walking frame comprising:
a first pivot piece and a second pivot piece pivotally mounted to each other about a pivot axis, wherein the first pivot piece and the second pivot piece are pivotally spaced apart from each other defining a pivot angle when in an open position, the first and second pivot pieces being pivotable within a pivot plane defined by the pivot angle, and the first and second pivot pieces being pivotable between the open position and a closed position, wherein the pivot angle is substantially zero when in the closed position;
a pair of beam assemblies, each of the pair of beam assemblies being segmented into an upper beam and a lower beam, the upper beam forming a handle at a distal end and a first end at a proximal end, the lower beam forming a foot at a distal end and a second end at a proximal end;
each of the first pivot piece and the second pivot piece comprises a first aperture and a second aperture, the first aperture and the second aperture being formed along a length of the respective pivot piece, and parallel to each other, the first aperture sized to slidably receive the first end and the second aperture sized to slidably receive the second end, the first end and the second end being received by the respective apertures in an opposing direction; and
each of the pair of beam assemblies being independently adjustable by extending and retracting each of the pair of beam assemblies along its length through one or more of the first aperture and the second aperture, enabling adjustment in height of the adjustable walking frame, and enabling adjustment in width defined between the handles when in the open position.

16. The adjustable walking frame of claim 15 further comprising a projecting stud and a curved slot, positioned to provide a pivotal trajectory between the first pivot piece and the second pivot piece when engaged, the curved slot being formed at the second pivot piece, the projecting stud being formed at the first pivot piece, wherein the projecting stud and the curved slot slidably mates across the pivot plane, the curved slot defined by the pivotal trajectory, the projecting stud being slidably locked into the curved slot, thereby pivotally engaging the two pieces firmly and moveably along the curved slot.

17. The adjustable walking frame of claim 15 further comprising a pivot locking member, configured to limit the first pivot piece and the second pivot piece from widening beyond a desired pivot angle, setting a maximum angle between the handles, or to limit the first pivot piece and the second pivot piece from inwardly pivoting towards each other beyond the closed position.

18. The adjustable walking frame of claim 15 wherein each of the upper beam and the lower beam further comprises a locking member releasably positioned to limit the extending and retracting of each of the pair of beam assemblies, when engaged.

19. A method of adjusting the device of claim 15 comprising the steps of:
reducing the width between the handles of the adjustable walking frame by retracting at least one of the upper beam of the pair of beam assemblies;
increasing the width between the handles of the adjustable walking frame by extending at least one of the upper beam of the pair of beam assemblies;
reducing the height of the adjustable walking frame by retracting at least one of the upper beam and the lower beam of the pair of beam assemblies; and
increasing the height of the adjustable walking frame by extending at least one of the upper beam and the lower beam of the pair of beam assemblies.

20. The method of adjusting the device of claim 19, further comprising the steps of:
collapsing the adjustable walking frame into a storage position by, fully retracting all of the upper beam and the lower beam, and pivoting the first pivot piece and the second pivot piece to the pivot angle of zero.
